(19) United States
(12) Patent Application Publication
(10) Pub. No.: US 2021/0258681 A1
(43) Pub. Date: Aug. 19, 2021

(54) ACOUSTIC SYSTEM CASING

(71) Applicant: Maksym Viktorovich CHYZHOV, Odessa (UA)

(72) Inventor: Maksym Viktorovich CHYZHOV, Odessa (UA)

(21) Appl. No.: 17/252,128

(22) PCT Filed: Jul. 11, 2018
(86) PCT No.: PCT/UA2018/000074

§ 371 Date: Dec. 14, 2020

(51) Int. Cl. H04R 1/28; H04R 1/02

(52) U.S. Cl. CPC H04R 1/288; H04R 1/025

(57) ABSTRACT

An acoustic system casing (1) which is in the form of a hollow three-dimensional body of extended spheroidal shape is proposed. A composite material consisting of a mineral substance (cement, ceramic) or a mineral substance with an organic binder (polyester resins, epoxy resins, etc.) is used as the casing material. The ratio of the longitudinal dimension of the casing to the width thereof is within the range of 1.2-2.0. The casing also contains an opening (3) for a loudspeaker (4), which opening is arranged at one of the axial ends of said casing. The invention eliminates vibration of a casing by eliminating parasitic oscillations and increases the maximum acoustic power of a loudspeaker at low frequencies, and also reduces the physical characteristics of a casing, that is, reduces the wall thickness and the total surface area of a casing.

### FIELD OF INVENTION

The invention refers to the acoustic systems and serves for the acoustic design of the electroacoustic converter (loudspeaker) installed in it. It can be used for household and professional purposes as an acoustic system.

### BACKGROUND

The closest analog to the present invention, according to the totality of features, is the casing of the acoustic system, which is made in a form of a hollow voluminous body of a spheroid shape, the walls of which are formed by a mineral material with a synthetic binding filler, which has a loudspeaker and contains an element that prevents the transmission of vibrations and resonances, which consists of a steel cable and shock absorber linking the casing and tether, and the free end of the cable is designed for the suspension of the acoustic system (see U.S. Pat. No. 6,705,426 published in 2004).

The present invention is similar with the known casing of the acoustic system on the following set of significant features, namely: the casing is made in the form of a hollow voluminous body of a spheroid shape, the walls of which are made of composite material and contains at least one hole for the loudspeaker.

However, the well-known speaker system does not achieve the declared technical result of the invention due to its design, namely: the non-symmetrical arrangement of the loudspeaker position relative to the axis of the system leads to the fact that the vibration energy in the low-frequency range at high power of the acoustic signal leads to the appearance of vibrations of the casing, which, combined with the elastic suspension of the casing hanging on the cable, increases the amplitude of the vibrations of the casing because there is no effective resistance to the vibrations of the loudspeaker, and, without having a natural outflow of vibrational energy into some kind of support, it causes uncontrolled radiation of the vibration energy into the surrounding space, resulting in low sound quality at low frequencies for high output power of the sound.

### SUMMARY

The aim of the invention is aimed is to improve the acoustic system by changing its design, which will allow to receive sound at the low frequencies with high output power without the appearance of vibrations of the casing, that is, in the absence of parasitic sound signals while improving the mass-size parameters of the casing, that is, reducing the thickness of the walls while reducing the total area of the surface of the casing surrounding the volume required for the functioning of the electro-acoustic converter of the low frequencies at high output power.

The task is solved in the acoustic system, the casing of which is made in a form of a hollow 3D casing of an elongated spheroid, the walls of which are made of composite material. The system has at least one hole for the speaker, the opening for the speaker is located on the side of the axial end, and the outer surface of the casing is formed by one or more arcs, with the center of each arc being on the opposite side of the axis of symmetry or on the axis of symmetry, with the ratio of longitudinal size to the width of the casing being within 1.2-2.0.

The present construction results in eliminating the parasitic vibration of the casing and increasing the maximum output sound power of the loudspeaker at low frequencies, in which there is no vibration of the casing that make sound distortions caused by the casing while reducing the mass-size characteristics of the casing, that is, reducing the thickness of the walls and reducing the total area of the surface of the casing, which covers the volume required for the sound of low-frequency at high power.

The additional technical result of the increased mechanical properties is achieved by the fact that the walls of the case are made of mineral material with an organic binder.

The additional technical result of the increased mechanical properties is achieved by the fact that the walls of the casing are made of mineral material with organic binders and reinforcement elements.

An additional technical result of the improved spread of the sound is achieved by an addition sound dispersion element located near the loudspeaker.

The additional technical result of the increased protection of the speaker's membrane from mechanical damage is achieved by a protective element surrounding the area of the acoustic wave output.

The additional technical result of the increased the working volume of the casing is achieved by adding of the sound-absorbing material.

The additional technical result of the eliminated rattling of the casing being installed on the uneven floor is achieved by the additional supporting elements in the form of spikes.

The additional technical result of the improved efficiency of the speaker system is achieved by the additional electronics control unit, signal processing unit and power amplifier.

### BRIEF DESCRIPTION OF THE DRAWINGS

The casing of the speaker system is explained by drawings depicting:

FIG. 1 Vertical incision of the casing of the acoustic system, the outer surface of which is formed from two arcs, the center of the radius of one of which is on the opposite side of the only axis of the symmetry of the casing, with a ratio of sides 1.29, that is, falls under the description of the present invention.

FIG. 2 Vertical incision of the casing with a ratio of sides 0.98, that is, does not fall under the description of the current invention.

FIG. 3 Vertical incision of the casing with a ratio of sides 2.05, that is, does not fall under the description of the invention.

FIG. 4 Vertical incision of the casing, where the centers of the arc radiuses are not on the opposite side of the axis of the symmetry of the casing, that is, does not fall under the description of the current invention.

FIG. 5 Photographic image of the acoustic measurements by an echo-free camera.

FIG. 6 Average level of resonance frequencies of the cubic corps MDF 22 mm having volume of 30 liters, 12 kg mask, in the interval of 10 Hz-10 kHz.

FIG. 7 Average level of own resonance frequencies of the casing according to the present invention, at the thickness of walls 10 mm, the volume of 30 liters, the weight of 12 kg, in the interval of 10 Hz-10 kHz.

### DETAILED DESCRIPTION OF THE PREFERRED EMBODIMENT

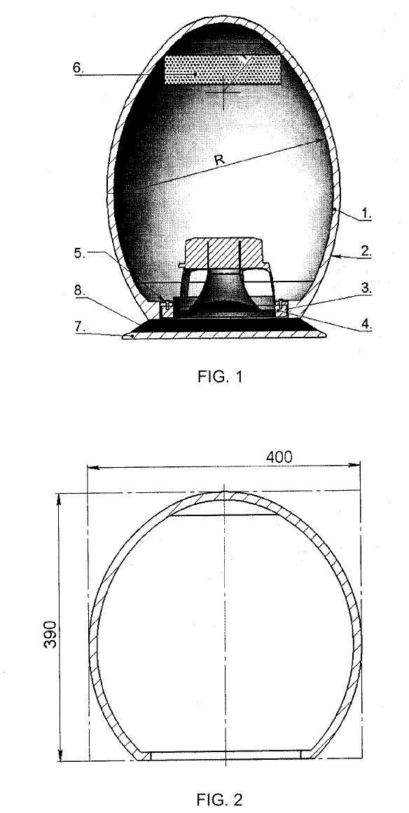

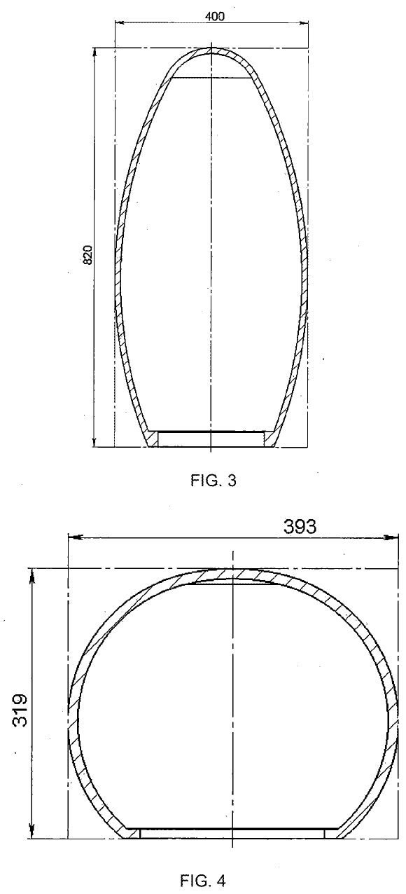

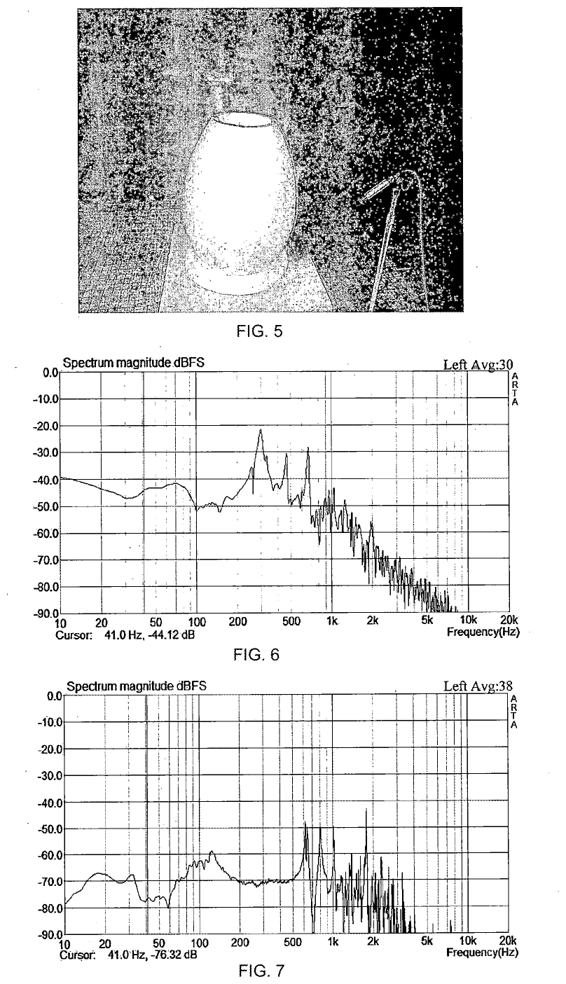

The proposed acoustic system (FIG. 1) includes a casing 1, made in the form of a hollow voluminous body of an elongated spheroid 2 with a single axis of symmetry. The casing 1 is made of a composite material including mineral composition (cement, ceramics) or mineral composition with an organic binder (polyester, epoxy resins and the like). The outer surface of the case is formed by one or more arcs, with the center of each arc R on FIG. 1 being on the opposite side of the axis of symmetry of the casing, or on the axis of symmetry of the casing. The maximal length-to-maximal width ratio of the casing is between 1.2 to 2.0. The casing has an opening 3, located on one of the axial ends of the casing, and it serves for placing the loudspeaker 4 and fixing it with the screws 5. The amplifier 6 is positioned, for example, above the top or bottom of the casing 1, and also it can be placed outside the casing 1. The stand 7 dissipates the sound and serves as the support of casing 1. The protective element 8 made of the soundproof material (grid, fabric) surrounds the loudspeaker 4, and/or the amplifier 6. When the loudspeaker produces low frequencies sound with large amplitudes, the loudspeaker is oriented upwards to ensure the acoustic wave output without the appearance of additional sound due to the turbulence of the airflow. A sound-scattering decorative soundproof protective element—fabric, mesh, and similar material—can be additionally installed above the loudspeaker. The loudspeaker 4 can be fixed both from the side of the opening 3 and from outside of the casing L It is necessary to ensure a rigid acoustico-mechanical connection between the loudspeaker 4 and the casing 1 with hermetic sealing of the connection. The casing can be made with a wall of variable thickness, for example, thicker in the middle part of the case and in the locking area of the loudspeaker, and thinner at the top of the casing. The part of the casing 1 opposite the opening 3 in the axial direction, which forms the upper part when the speaker is fixed in the bottom of the casing, can be made truncated, with the aim of installing functional controls, decorative elements, and other functional acoustic elements. The amplifier 7 can be installed in any part of the casing 1, preferably in the part of the casing opposite to the loudspeaker 4.

The proposed speaker system works as follows. The membrane the loudspeaker 4 performs reciprocal vibrations during its operation. Part of the energy of these vibrations is transmitted to the casing 1 where the speaker 4 is attached to the casing 1, and part of the energy forms pressure fluctuations inside the casing 1. Thus, the casing 1 is subjected to longitudinal and transverse loads. The casing 1 has an axial-symmetrical shape, and is made of concrete or polymer concrete or similar materials, and the arcs 2 have centers on the opposite side of the axis of symmetry of the casing 1, with the ratio of maximal length-to maximal width of the casing within 1.2-2.0, and the loudspeaker 4 is installed on the side of the axial end, symmetrically. Because of this construction the vibrational energy from the speaker is transferred predominantly along the solid material of the casing and provides minimal vibration amplitudes of the casing 1. It does not lead to the destruction of the casing 1, when its walls have a small thickness, for example, 10 mm. At the same time, also due to the combination of the hardness of the material and the shape of the casing and the location of the loudspeaker 4, there is no cross (normal to the axis) vibrations of the walls of the casing 1.

Thus, there are no vibration of the casing 1 relative to the loudspeaker 4. The operation of the casing 1 occurs the casing is in a vertical position thus providing the best acoustic-mechanical connection of the casing 1 and the support (floor), which is equivalent to the increase of the equivalent mass of the acoustic system, thus eliminating vibrations against the floor, along the direction of the largest vibration loads of the casing as a whole.

An illustration of the technical result of the claimed invention, which is in the improvement of acoustic characteristics and reduction of the mass and size of the system, is spectrograms, measured in the near field from the two types of casings of the same internal volumes and mass, after generating their vibrations at their own frequencies by the method of hitting a rubber bullet dropped from a constant height. The results have been averaged after five experiments:

In FIG. 6 the average level of the system's own resonances in the interval of 10 Hz-100 Hz is −45 db, Where the maximum is in frequencies of 300, 450, 770 Hz.

In FIG. 7 the average level of the system's own resonances in the interval of 10 Hz-100 Hz is −75 db, and the maximum is on frequencies of 600, 800, 1000 Hz, 1800 Hz.

Thus, the claimed invention cannot be used as an acoustic design of a medium-frequency loudspeaker, but provides a reduction in the average level of its own resonance frequencies to a level of −40 dB (10,000 times reduction of the amplitude) at a frequency of 10 Hz, to −15 dB (36 times reduction of the amplitude) at 100 Hz, while in the area of upper bass 100 Hz-500 Hz, the clarity of solid sounds has the reduction of the resonant frequencies to the level −48 dB (46000 times reduction of the amplitude).

### INDUSTRIAL APPLICABILITY

The invention can be used for domestic and professional purposes as an acoustic system.

What is claimed is:

1. A casing of a speaker system, made in a form of a hollow voluminous casing in a form of an elongated spheroid, walls of which are made of composite material and contain at least one opening for the speaker, differs in that the speaker opening is located on an axial end of the casing, and an outer surface of the case is formed by one or more arcs, with a center of each arc being on the opposite side of an axis of symmetry of the casing or on the axis of symmetry, with a ratio of longitudinal size to the maximal width of the casing being within 1.2-2.0.

2. The casing of claim 1 that differs in that the walls of the casing are made of a mineral material with an organic binder.

3. The casing of claim 1 that differs in that the walls of the casing are made of a mineral material with organic binder and reinforcement elements.

4. The casing of claim 1 further comprising a sound-scattering element in front of the speaker.

5. The casing of claim 1 that further comprising a protective or decorative sound-penetrating element surrounding area of the acoustic wave output.

6. The casing of claim 1 wherein the casing is made of sound absorbing material.

7. The casing of claim 1 further comprising supporting elements in a form of spikes.

8. The casing of claim 1 further comprising an electronics control unit, a signal processing unit and a power amplifier.
